(19) United States
(12) Patent Application Publication
(10) Pub. No.: US 2014/0140046 A1
(43) Pub. Date: May 22, 2014

(54) LIGHT-EMITTING DEVICE AND DISPLAY APPARATUS

(71) Applicants: Yasuhiro Ono, Osaka-shi (JP); Makoto Masuda, Osaka-shi (JP); Kenzo Ohkubo, Osaka-shi (JP); Nobuhiro Shirai, Osaka-shi (JP); Takasumi Wada, Osaka-shi (JP)

(72) Inventors: Yasuhiro Ono, Osaka-shi (JP); Makoto Masuda, Osaka-shi (JP); Kenzo Ohkubo, Osaka-shi (JP); Nobuhiro Shirai, Osaka-shi (JP); Takasumi Wada, Osaka-shi (JP)

(73) Assignee: SHARP KABUSHIKI KAISHA, Osaka-shi, Osaka (JP)

(21) Appl. No.: 14/130,223

(22) PCT Filed: May 22, 2012
(86) PCT No.: PCT/JP2012/063053

§ 371 Date: Feb. 6, 2014

(30) Foreign Application Priority Data
Jul. 6, 2011 (JP) 2011-150474

(51) Int. Cl. F21V 7/00; G02F 1/1335

(52) U.S. Cl. CPC F21V 7/00; G02F 1/133605
USPC 362/97.1

(57) ABSTRACT

There are provided a light-emitting device for use in a backlight unit of a display apparatus equipped with a display panel, which can be made lower in profile and is capable of applying light to the display panel with uniformity in the brightness of the display panel in a planar direction of the display panel, as well as a display apparatus equipped with the light-emitting device. A backlight unit includes a plurality of light-emitting devices each having a printed substrate, a base support, an LED chip and a lens, and a reflective member surrounding the light-emitting device. A high-reflection portion is formed in a first reflective region of the reflective member.

### TECHNICAL FIELD

The present invention relates to a light-emitting device which is provided in a backlight unit for applying light to a back side of a display panel, and a display apparatus equipped with the light-emitting device.

### BACKGROUND ART

In a display panel, a liquid crystal is sealed in between two transparent substrates, and, upon application of voltage, the orientations of liquid crystal molecules are changed with consequent variations in light transmittance, thereby permitting the display of a predetermined image or the like in an optical manner. In the display panel, the liquid crystal is not a light emitter in itself, wherefore, for example, the display panel of a transmissive type has, at its back side, a backlight unit for light irradiation using a light source such as a cold-cathode fluorescent lamp (CCFL) or a light-emitting diode (LED).

Backlight units are classified into two categories, namely a direct-lighting type in which light sources such as cold-cathode fluorescent lamps or LEDs are arranged at the bottom for light emission, and an edge-lighting type in which light sources such as cold-cathode fluorescent lamps or LEDs are arranged at an edge portion of a transparent plate called a light guide plate, so that light can be directed forward, through printed dots or patterns formed at the back, from the edge of the light guide plate.

Although the LED has excellent characteristics, including lower power consumption, longer service life, and the capability of reduction in environmental burdens without the use of mercury, its use as a light source for a backlight unit has fallen behind because of its expensiveness, the fact that there had been no white-color LED prior to the invention of a blue-color LED, and its high directivity. However, in recent years, as white-color LEDs exhibiting high color rendition and high brightness spring into wide use for illumination application purposes, LEDs are becoming less expensive, and consequently, as a light source for a backlight unit, the shift from the cold-cathode fluorescent lamp to the LED has picked up momentum.

LEDs have high directivity, wherefore a backlight unit of edge-lighting type has the advantage over a backlight unit of direct-lighting type from the standpoint of effecting light irradiation in a manner such that a display panel can exhibit uniform surface brightness in a planar direction. However, the edge-lighting type backlight unit poses the following problems: localized arrangement of light sources at the edge portion of the light guide plate results in concentration of heat generated by the light sources; and the size of the bezel portion of the display panel is inevitably increased. Furthermore, the edge-lighting type backlight unit is subjected to severe restrictions in terms of local dimming control which attracts attention as a control technique capable of display of high-quality images and energy saving, and is therefore incapable of split-region control that achieves production of high-quality displayed images and low power consumption as well.

In view of the foregoing, studies are going on to come up with a method whereby, even if a highly-directive LED is used as a light source in a direct-lighting type backlight unit having an advantage in its suitability for local dimming control, light can be applied to a display panel in manner such that the brightness of an object to be illuminated is rendered uniform in the planar direction of the to-be-illuminated object.

For example, in Patent Literature 1, there is disclosed an inverted cone-shaped light-emitting lamp including a light-emitting element, a resin lens having an inverted cone-shaped recess disposed so as to cover the light-emitting element, and a reflective plate disposed around the resin lens. Moreover, in Patent Literature 2, there is disclosed a light-source unit including a light-emitting element and a light-guide reflective body for guiding light emitted from the light-emitting element while reflecting the light in a direction perpendicular to an optical axis.

### CITATION LIST

### Patent Literature

Patent Literature 1: Japanese Unexamined Patent Publication JP-A 61-127186 (1986)
Patent Literature 2: Japanese Unexamined Patent Publication JP-A 2010-238420

### SUMMARY OF INVENTION

### Technical Problem

According to the technologies as disclosed in Patent Literatures 1 and 2, light having high directional property emitted from a light-emitting element is diffused in a direction intersected by the optical axis of the light-emitting element, so that a display panel can be irradiated with the light in the planar direction thereof.

In keeping with the recent increasing demand for a display apparatus of even lower profile, a light-emitting device of direct-lighting type that is to be mounted in such a slimmed-down display apparatus is required to have the capability of allowing light emitted from a light-emitting element to diffuse in a direction intersected by the optical axis of the light-emitting element with high accuracy. However, the technologies as disclosed in Patent Literatures 1 and 2 cannot fully satisfy the above requirement.

For example, in the technology disclosed in Patent Literature 2, the light-emitting element is disposed in the center of the bottom of the reflective plate, and the reflective plate has a quadrangular outer shape, and also the side wall of the reflective plate is disposed perpendicularly with respect to the bottom of the reflective plate. In such a case where the reflective plate has a polygonal outer shape, the distance from the light-emitting element to a corner of the polygonal shape is longer than the distance from the light-emitting element to a side thereof, with the consequence that the quantity of light applied to a part of the display panel which faces the corner is smaller than the quantity of light applied to a part of the display panel which faces the side, which leads to unevenness in the quantity of light applied to the display panel.

An object of the invention is to provide a light-emitting device for use in a backlight unit of a display apparatus equipped with a display panel, which can be made lower in profile and is capable of applying light to the display panel with uniformity in the brightness of the display panel in the planar direction of the display panel, as well as to provide a display apparatus equipped with the light-emitting device.

### Solution to Problem

The invention provides a light-emitting device for illuminating an object to be illuminated, comprising:

a light-emitting section for applying light to a to-be-illuminated object; and

a reflective member disposed around the light-emitting section,

the reflective member being polygonal in outer shape as viewed in a plan view from a to-be-illuminated object side,

when viewed in a plan view from the to-be-illuminated object side, an average total reflectivity between a total reflectivity of a corner part of the reflective member and a total reflectivity of a first reflective region, which is a region between the corner part and the light-emitting section, is greater than an average total reflectivity between a total reflectivity of a side of the reflective member and a total reflectivity of a second reflective region, which is a region between the side and the light-emitting section,

the light-emitting section being located in a center of the reflective member as viewed in a plan view from the to-be-illuminated object side.

In the invention, it is preferable that the reflective member has, in the first reflective region thereof, a first reference reflective portion having a predetermined total reflectivity and a high-reflection portion having a total reflectivity higher than the predetermined total reflectivity, and

total reflectivities of the corner part, the side, and the second reflective region are equal to the predetermined total reflectivity.

Moreover, in the invention, it is preferable that the reflective member has, in the second reflective region thereof, a second reference reflective portion having a predetermined total reflectivity and a first low-reflection portion having a total reflectivity lower than the predetermined total reflectivity, and

total reflectivities of the corner part, the side, and the first reflective region are equal to the predetermined total reflectivity.

Moreover, in the invention, it is preferable that the reflective member has, in the side thereof, a third reference reflective portion having a predetermined total reflectivity and a second low-reflection portion having a total reflectivity lower than the predetermined total reflectivity, and

total reflectivities of the corner part, the first reflective region, and the second reflective region are equal to the predetermined total reflectivity.

Moreover, in the invention, it is preferable that the reflective member has, in the first reflective region thereof, a first reference reflective portion having a predetermined total reflectivity and a high-reflection portion having a total reflectivity higher than the predetermined total reflectivity, and has, in the second reflective region thereof, a second reference reflective portion having a predetermined total reflectivity and a first low-reflection portion having a total reflectivity lower than the predetermined total reflectivity, and

total reflectivities of the corner part and the side are equal to the predetermined total reflectivity.

Moreover, in the invention, it is preferable that a diffuse reflection range of the high-reflection portion is narrower than a diffuse reflection range of the second reflective region.

Moreover, in the invention, it is preferable that a diffuse reflection range of the first low-reflection portion is broader than a diffuse reflection range of the first reflective region.

Moreover, in the invention, it is preferable that a diffuse reflection range of the second low-reflection portion is broader than a diffuse reflection range of the first reflective region.

Moreover, in the invention, it is preferable that a diffuse reflection range of the high-reflection portion is narrower than a diffuse reflection range of the first reference reflective portion,

a diffuse reflection range of the first low-reflection portion is broader than the diffuse reflection range of the first reference reflective portion, and

a diffuse reflection range of the second reference reflective portion is equal to the diffuse reflection range of the first reference reflective portion.

Moreover, in the invention, it is preferable that the reflective member comprises a base portion which surrounds the light-emitting element, and an inclined portion which surrounds the base portion and is inclined so as to get closer to the to-be-illuminated object as a distance from the light-emitting element increases.

Moreover, the invention provides a display apparatus comprising:

a display panel; and

an illuminating apparatus including the light-emitting device for applying light to a back side of the display panel.

### Advantageous Effects of Invention

According to the invention, in the reflective member, the average total reflectivity between the total reflectivity of the corner part and the total reflectivity of the first reflective region is greater than the average total reflectivity between the total reflectivity of the side and the total reflectivity of the second reflective region, wherefore the ratio of the quantity of light that has been reflected from the first reflective region and the corner part and has reached the to-be-illuminated object to the quantity of light that has been reflected from the second reflective region and the side and has reached the to-be-illuminated object becomes larger than ever. That is, the ratio of the quantity of light reaching a part of the to-be-illuminated object opposed to the corner part of the reflective member to the quantity of light reaching a part of the to-be-illuminated object opposed to the side of the reflective member becomes larger than ever. As a result, light applied to the to-be-illuminated object can be rendered uniform.

According to the invention, by virtue of the high-reflection portion which is formed in the first reflective region and has a total reflectivity higher than the total reflectivities of the first reference reflective portion, the corner part, the side, and the second reflective region, the quantity of light reaching the part of the to-be-illuminated object opposed to the corner part of the reflective member can be increased. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, by virtue of the first low-reflection portion which is formed in the second reflective region and has a total reflectivity lower than the total reflectivities of the second reference reflective portion, the corner part, the side, and the first reflective region, the quantity of light reaching the part of the to-be-illuminated object opposed to the side of the reflective member can be reduced. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, by virtue of the second low-reflection portion which is formed in the side of the reflective member and has a total reflectivity lower than the total reflectivities of the third reference reflective portion, the corner part, the first reflective region, and the second reflective region, the quantity of light reaching the part of the to-be-illuminated object opposed to the side of the reflective member can be reduced. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, by virtue of the high-reflection portion which is formed in the first reflective region and has a total reflectivity higher than the total reflectivities of the first reference reflective portion, the corner part, the side, and the second reflective region, the quantity of light reaching the part of the to-be-illuminated object opposed to the corner part of the reflective member can be increased, and also, by virtue of the first low-reflection portion which is formed in the second reflective region of the reflective member and has a total reflectivity lower than the total reflectivities of the first reference reflective portion, the second reference reflective portion, the high-reflection portion, the corner part, and the side, the quantity of light reaching the part of the to-be-illuminated object opposed to the side of the reflective member can be reduced. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, the diffuse reflection range of the high-reflection portion is narrower than the diffuse reflection range of the second reflective region. That is, light reflected from the high-reflection portion is diffused over a range narrower than the range over which light reflected from the second reflective region is diffused. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, the diffuse reflection range of the first low-reflection portion is broader than the diffuse reflection range of the first reflective region. That is, light reflected from the first low-reflection portion is diffused over a range broader than the range over which light reflected from the first reflective region is diffused. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, the diffuse reflection range of the second low-reflection portion is broader than the diffuse reflection range of the first reflective region. That is, light reflected from the second low-reflection portion is diffused over a range broader than the range over which light reflected from the first reflective region is diffused. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, the diffuse reflection range of the high-reflection portion is narrower than the diffuse reflection range of the first reference reflective portion; the diffuse reflection range of the first low-reflection portion is broader than the diffuse reflection range of the first reference reflective portion; and the diffuse reflection range of the second reference reflective portion is equal to the diffuse reflection range of the first reference reflective portion. That is, light reflected from the first low-reflection portion is diffused over a range broader than the range over which light reflected from the high-reflection portion is diffused. This makes it possible to increase the ratio of the quantity of light reaching the part of the to-be-illuminated object opposed to the corner part of the reflective member to the quantity of light reaching the part of the to-be-illuminated object opposed to the side of the reflective member even further than ever, and thereby render light applied to the to-be-illuminated object uniform.

According to the invention, since the inclined portion is inclined so as to get closer to the to-be-illuminated object as the distance from the light-emitting element increases, it follows that light emitted from the light-emitting element is readily caused to reach the part of the to-be-illuminated object opposed to the side, as well as the corner part, of the reflective member. Accordingly, light applied to the to-be-illuminated object can be rendered uniform.

According to the invention, the display apparatus is configured to apply light to the back side of the display panel by means of the illuminating apparatus including the light-emitting device, and is therefore capable of displaying images of even higher quality.

### BRIEF DESCRIPTION OF DRAWINGS

Other and further objects, features, and advantages of the invention will be more explicit from the following detailed description taken with reference to the drawings wherein:

FIG. 1 is an exploded perspective view showing the structure of a liquid-crystal display apparatus;

FIG. 2A is a view schematically showing the section of the liquid-crystal display apparatus taken along the line A-A of FIG. 1;

FIG. 2B is a view schematically showing the section of the liquid-crystal display apparatus taken along the line B-B of FIG. 1;

FIG. 3A is a view showing the positional relationship between an LED chip supported by a base support and a lens;

FIG. 3B is a view showing the base support and the LED chip;

FIG. 3C is a view showing the base support and the LED chip;

FIG. 3D is a view showing the base support and the LED chip;

FIG. 3E is a view showing the LED chip and the base support which are mounted on a printed substrate;

FIG. 4 is a view for explaining an optical path of light emitted from the LED chip;

FIG. 5 is a perspective view of a reflective member and the lens;

FIG. 6 is a view showing the reflective member and the lens as viewed in a plan view in an X direction;

FIG. 7 is a view showing a modified example of a first embodiment;

FIG. 8 is a perspective view showing a light-emitting section and the reflective member;

FIG. 9 is a view showing the reflective member and the lens as viewed in a plan view in the X direction;

FIG. 10 is a view showing a modified example of a second embodiment;

FIG. 11 is a view showing the reflective member and the lens as viewed in a plan view in the X direction; and

FIG. 12 is a view showing the reflective member and the lens as viewed in a plan view in the X direction.

### DESCRIPTION OF EMBODIMENTS

Hereinafter, preferred embodiments of the invention will be described in detail with reference to the drawings.

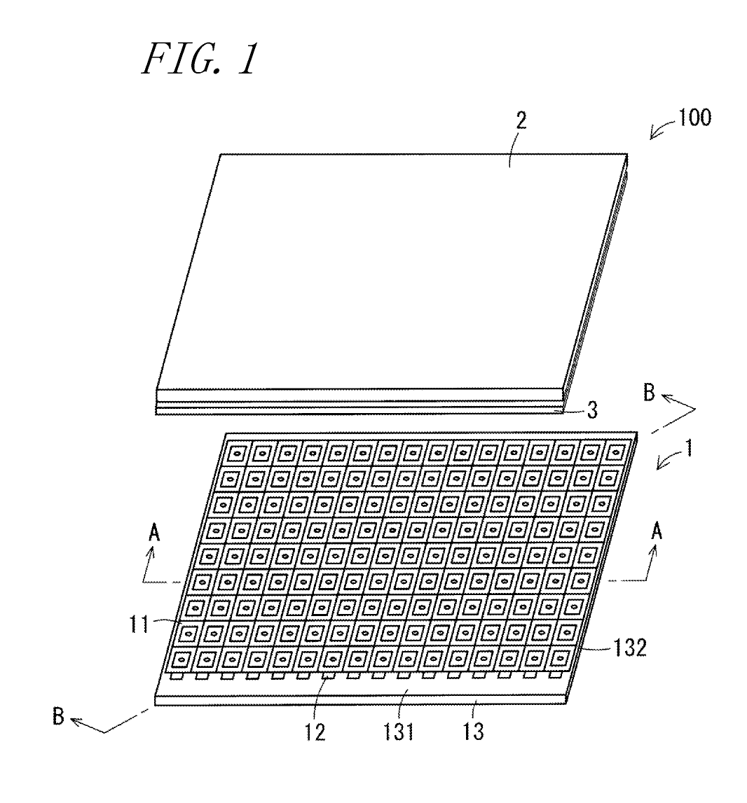

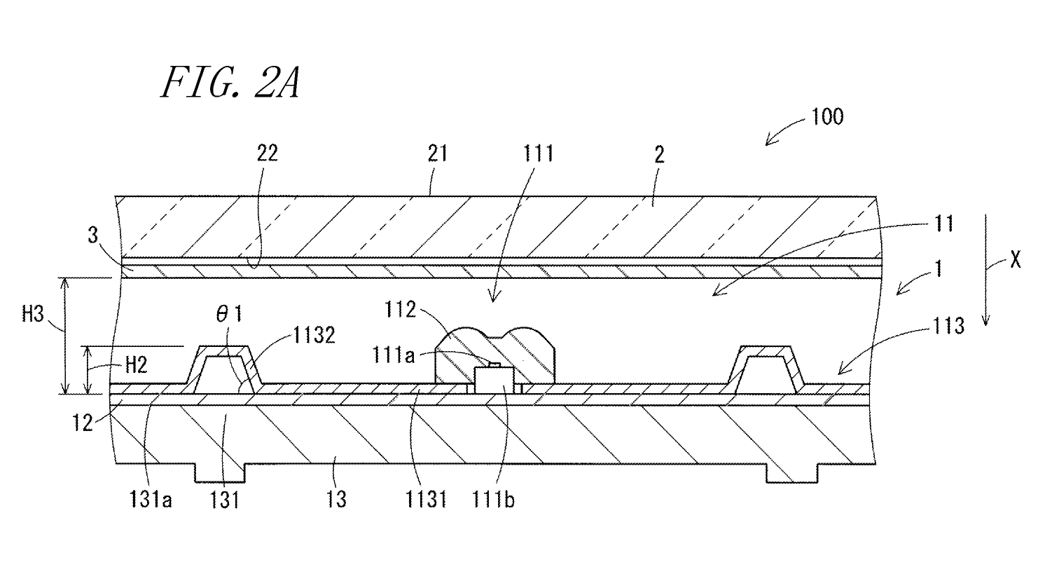

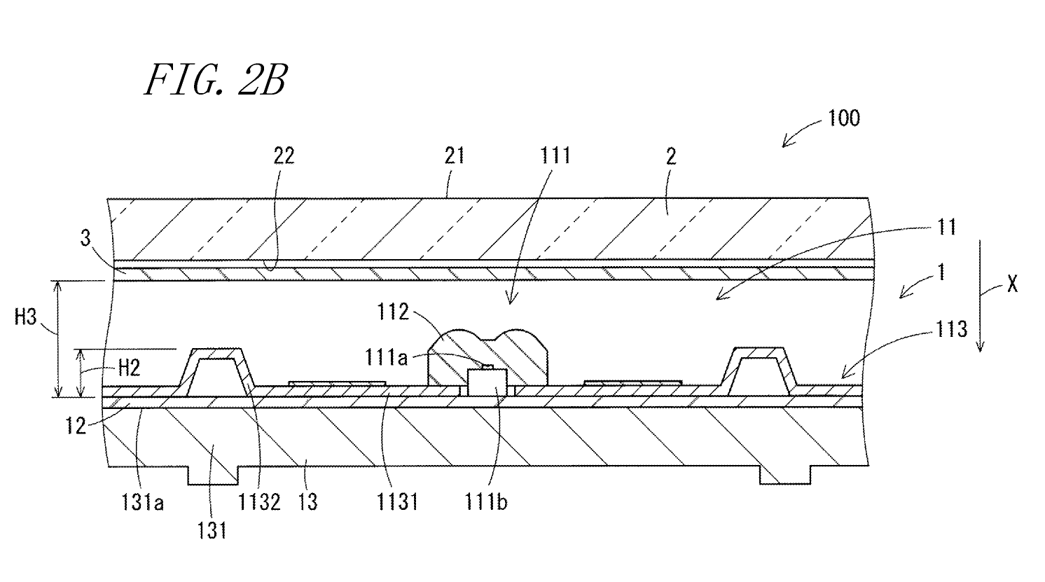

FIG. 1 is an exploded perspective view showing the structure of a liquid-crystal display apparatus 100 in accordance with a first embodiment of the invention. FIG. 2A is a view schematically showing the section of the liquid-crystal display apparatus 100 taken along the line A-A of FIG. 1. FIG. 2B is a view schematically showing the section of the liquid-crystal display apparatus 100 taken along the line B-B of FIG. 1. The liquid-crystal display apparatus 100 which is a display apparatus according to the invention is designed for use in television sets, personal computers, and so forth, for showing an image on a display screen in response to output of image information. The display screen is constructed of a liquid-crystal panel 2 which is a transmissive display panel having liquid-crystal elements, and the liquid-crystal panel 2 has the form of a rectangular flat plate. In the liquid-crystal panel 2, two sides in the thickness-wise direction thereof will be referred to as a front side 21 and a back side 22, respectively. The liquid-crystal display apparatus 100 shows an image in a manner such that the image is viewable in a direction from the front side 21 to the back side 22.

The liquid-crystal display apparatus 100 comprises the liquid-crystal panel 2 and a backlight unit 1 including a light-emitting device pursuant to the invention. The liquid-crystal panel 2 is supported on a sidewall portion 132 in parallel to a bottom surface 131a of a bottom portion 131 of a frame member 13 provided in the backlight unit 1. The liquid-crystal panel 2 includes two substrates, and is shaped like a rectangular plate when viewed in the thickness-wise direction. The liquid-crystal panel 2 includes a switching element such as a TFT (thin film transistor), and liquid crystal is filled in a gap between the two substrates. The liquid-crystal panel 2 performs a display function through irradiation of light from the backlight unit 1 placed on the back side 22 as backlight. The two substrates are provided with a driver (source driver) used for pixel driving control in the liquid-crystal panel 2, and various elements and wiring lines.

Moreover, in the liquid-crystal display apparatus 100, a diffusion plate 3 is disposed between the liquid-crystal panel 2 and the backlight unit 1 in parallel to the liquid-crystal panel 2. A prism sheet may be interposed between the liquid-crystal panel 2 and the diffusion plate 3.

The diffusion plate 3 diffuses light emitted from the backlight unit 1 in the planar direction to prevent localized brightness variations. The prism sheet controls a traveling direction of light that has reached there from the back side 22 through the diffusion plate 3 so that the light can be directed toward the front side 21. In the diffusion plate 3, to prevent lack of uniformity in brightness in the planar direction, the traveling direction of light involves, as vector components, many planar-directional components. On the other hand, in the prism sheet, the traveling direction of light involving many planar-directional vector components is converted into a traveling direction of light involving many thickness-directional components. Specifically, the prism sheet is formed by arranging a large number of lenses or prism-like portions in the planar direction, and this arrangement allows reduction in the degree of diffusion of light traveling in the thickness-wise direction. This makes it possible to enhance the brightness of the display in the liquid-crystal display apparatus 100.

The backlight unit 1 is a backlight device of direct-lighting type for applying light to the liquid-crystal panel 2 from the back side 22. The backlight unit 1 includes a plurality of light-emitting devices 11 for applying light to the liquid-crystal panel 2, a plurality of printed substrates 12, and the frame member 13.

The frame member 13 serves as a basic structure of the backlight unit 1, and comprises the flat plate-shaped bottom portion 131 opposed to the liquid-crystal panel 2, with a predetermined spacing secured between them, and the sidewall portion 132 which is continuous with the bottom portion 131 so as to extend upright therefrom. The bottom portion 131 is rectangular-shaped when viewed in the thickness-wise direction, and its size is slightly larger than the size of the liquid-crystal panel 2. The sidewall portion 132 is formed so as to extend upright toward the front side 21 of the liquid-crystal panel 2 from each of two ends corresponding to the short sides of the bottom portion 131 and another two ends corresponding to the long sides thereof. Thus, four flat plate-shaped sidewall portions 132 are formed along the periphery of the bottom portion 131.

The printed substrate 12 is fixed to the bottom portion 131 of the frame member 13. On the printed substrate 12 are arranged a plurality of light-emitting devices 11. The printed substrate 12 is, for example, a glass epoxy-made substrate having an electrically-conductive layer formed on each side.

A plurality of light-emitting devices 11 are intended to apply light to the liquid-crystal panel 2. In this embodiment, the plurality of light-emitting devices 11 are arranged in a group, and, a plurality of printed substrates 12 each having the plurality of light-emitting devices 11 are juxtaposed so as to face the entire area of the back side 22 of the liquid-crystal panel 2, with the diffusion plate 3 lying between them, thereby providing matrix arrangement of the light-emitting devices 11. Each of the light-emitting devices 11, which is square-shaped when viewed in a plan view in an X direction perpendicular to the bottom portion 131 of the frame member 13, is designed so that the brightness of the liquid-crystal panel 2-sided surface of the diffusion plate 3 stands at 6000 cd/m², and the length of a side of the square shape is set at 40 mm, for example.

Each of the plurality of light-emitting devices 11 comprises a light-emitting section 111, and a reflective member 113 placed around the light-emitting section 111 on the printed substrate 12. The light-emitting section 111 includes a light-emitting diode (LED) chip 111a which is a light-emitting element, a base support 111b for supporting the LED chip 111a, and a lens 112 which is an optical member.

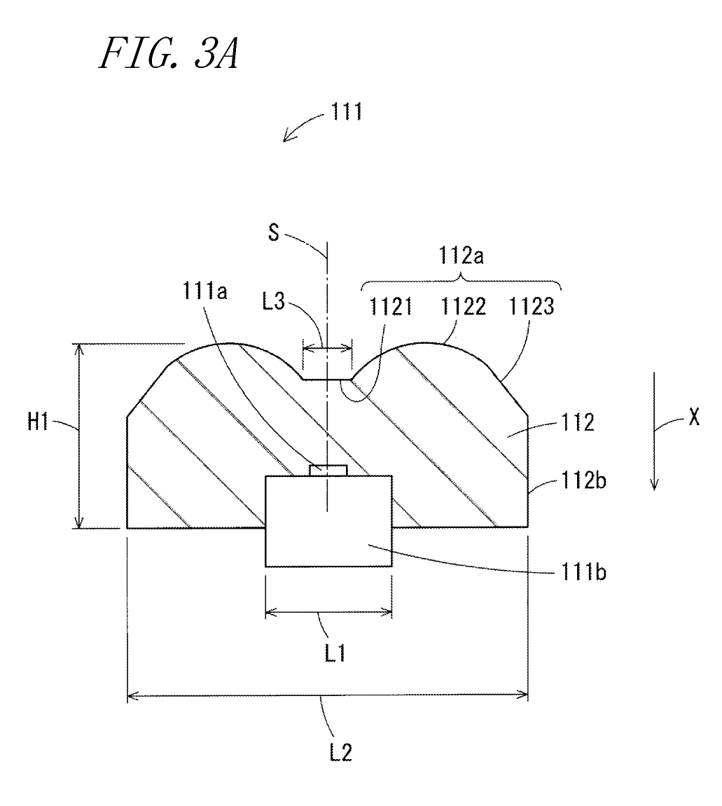

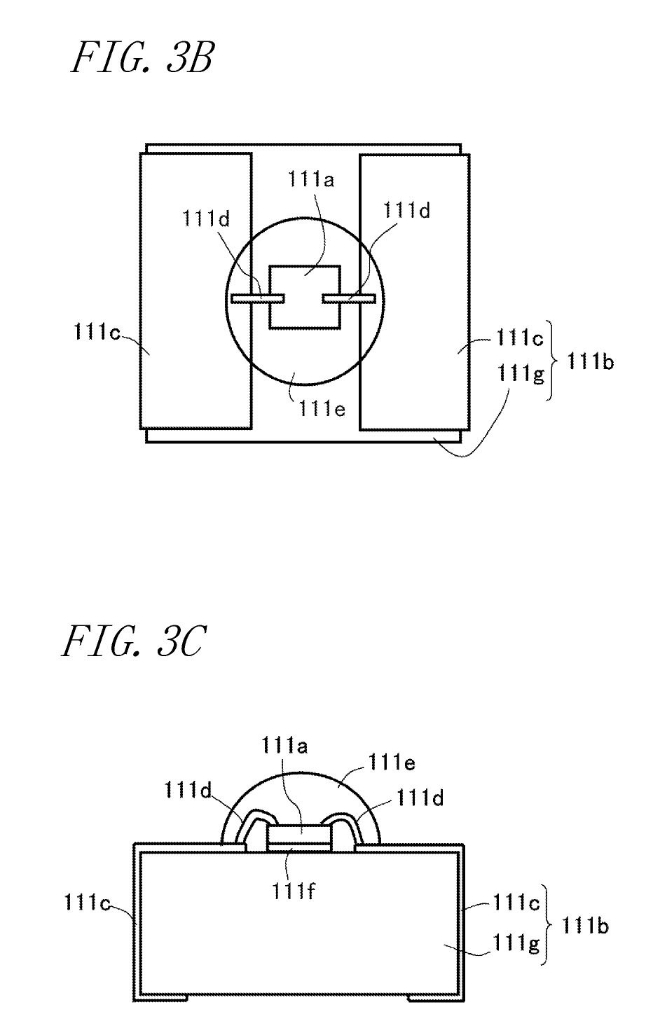

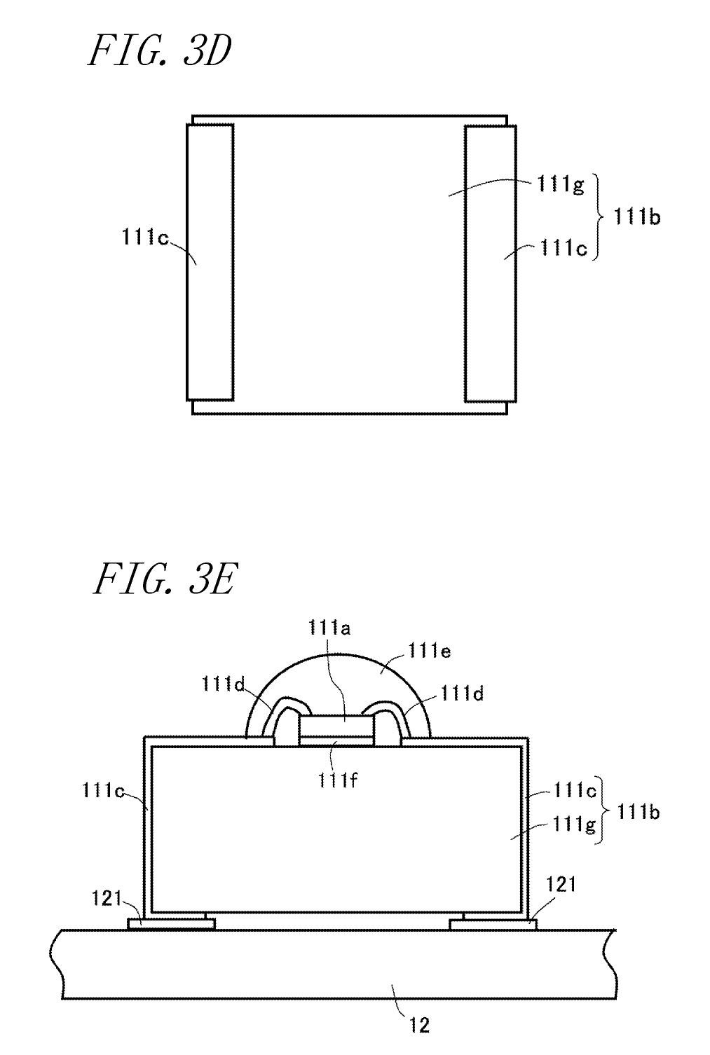

FIG. 3A is a view showing the positional relationship between the LED chip 111a supported by the base support 111b and the lens 112.

The base support 111b is a member for supporting the LED chip 111a. In the base support 111b, its support surface for supporting the LED chip 111a is square-shaped when viewed in a plan view in the X direction, and a length L1 of a side of the square shape is set at 3 mm, for example. Moreover, the height of the base support 111b is set at 1 mm, for example.

FIGS. 3B to 3D are views showing the base support 111b and the LED chip 111a, of which FIG. 3B is a plan view, FIG. 3C is a front view, and FIG. 3D is a bottom view. As shown in FIGS. 3B to 3D, the base support 111b includes a base main body 111g made of ceramics, and two electrodes 111c disposed on the base main body 111g, and, the LED chip 111a is secured to a center of the top surface of the base main body 111g serving as the support surface of the base support 111b by a bonding member 111f. The two electrodes 111c, which are spaced apart from each other, each extend over the top surface, side surface, and bottom surface of the base main body 111g.

Two terminals (not shown) of the LED chip 111a are connected to the two electrodes 111c by two bonding wires 111d, respectively. The LED chip 111a and the bonding wire 111d are sealed with a transparent resin 111e such as silicon resin.

FIG. 3E shows the LED chip 111a and the base support 111b which are mounted on the printed substrate 12. The LED chip 111a is mounted on the printed substrate 12, with the base support 111b lying between them, for emitting light in a direction away from the printed substrate 12. When the light-emitting device 11 is viewed in a plan view in the X direction, the LED chip 111a is located in a center of the base support 111b. In the plurality of light-emitting devices 11, their LED chips 111a can be controlled on an individual basis in respect of light emission. This allows the backlight unit 1 to perform local dimming control.

When mounting LED chip 111a and the base support 111b on the printed substrate 12, solder is applied onto each of two connection terminal portions 121 of an electrically-conductive layer pattern provided in the printed substrate 12, and the base support 111b and the LED chip 111a fixed to the base support 111b are placed on the printed substrate 12 so that the two electrodes 111c disposed on the bottom surface of the base main body 111g can be brought into registry with their respective solders by an automated machine (not shown), for example. The printed substrate 12 bearing the base support 111b and the LED chip 111a fixed to the base support 111b is delivered to a reflow bath for infrared radiation, and the solder is heated to a temperature of about 260° C., whereby the base support 111b is soldered to the printed substrate 12.

The lens 112, which is disposed in contact with the LED chip 111a so as to cover the base support 111b supporting the LED chip 111a by means of insert molding, allows light emitted from the LED chip 111a to undergo reflection or refraction in a plurality of directions. That is, the lens effects light diffusion. The lens 112 is a transparent lens made for example of silicon resin or acrylic resin.

The lens 112 is substantially cylindrically shaped, with its top surface 112a facing the liquid-crystal panel 2 curved so as to provide a recess in a center thereof, and with its side surface 112b kept in parallel with an optical axis S of the LED chip 111a, and a diameter L2 of its section perpendicular to the optical axis S is set at 10 mm, for example, and also, the lens 112 extends outward relative to the base support 111b.

That is, the lens 112 is larger than the base support 111b with respect to a direction perpendicular to the optical axis S of the LED chip 111a (the diameter L2 of the lens 112 is greater than the length L1 of one side of the support surface of the base support 111b). Thus, where the lens 112 extends outward relative to the base support 111b, light emitted from the LED chip 111a can be diffused over an even broader range by the lens 112.

Moreover, a height H1 of the lens 112 is set at 4.5 mm, for example, which is smaller than the diameter L2. In other words, the lens 112 is so configured that its length in a direction perpendicular to the optical axis S of the LED chip 111a (the diameter L2) is greater than the height H1. Light incident on the lens 112 is diffused in a direction intersected by the optical axis S in the interior of the lens 112.

The reason why the diameter L2 is set to be greater than the height H1 as described above is to make the backlight unit 1 lower in profile, as well as to ensure that light can be applied evenly to the liquid-crystal panel 2. In order to make the backlight unit 1 lower in profile, the height H1 of the lens 112 needs to be minimized; that is, the lens 112 needs to be thinned as much as possible. However, the reduction in thickness of the lens 112 is likely to cause illuminance variations at the back side 22 of the liquid-crystal panel 2, which may result in lack of uniformity in brightness at the front side 21 of the liquid-crystal panel 2. Especially in a case where a distance between the adjacent LED chips 111a is long, a region between the LED chips 111a arranged adjacent each other at the back side 22 of the liquid-crystal panel 2 is located far away from the LED chip 111a, wherefore the quantity of light applied to that region becomes small, which is likely to cause illuminance (brightness) variations between that region and a region close to the LED chip 111a. In order to ensure that the region located far away from the LED chip 111a can be irradiated with light emitted from the LED chip 111a via the lens 112, it is necessary to increase the diameter L2 of the lens 112 to a certain extent, and thus, in this embodiment, the slimming-down of the backlight unit 1 and uniform application of light to the liquid-crystal panel 2 can be achieved by setting the diameter L2 to be greater than the height H1 in the lens 112.

If the diameter L2 of the lens 112 is set to be smaller than the height H1 of the lens 112, it will be difficult to achieve the slimming-down of the backlight unit and uniform light application, and in addition, in the process of insert molding for forming the lens 112 in alignment with the LED chip 111a, the lens and the LED chip are likely to get out of balance. Furthermore, when the light-emitting section 111 comprising the LED chip 111a, the base support 111b, and the lens 112 formed by means of insert molding is soldered to the printed substrate 12, they are likely to get out of balance, which results in assembly problems.

The top surface 112a of the lens 112 includes a central portion 1121, a first curved portion 1122, and a second curved portion 1123. In the lens 112, the top surface 112a curved so as to provide the central recess comprises a first region where reaching light is reflected for its exit from the side surface 112b, and a second region where reaching light is refracted outward for its exit from the top surface 112a. The first region is formed in the first curved portion 1122, and the second region is formed in the second curved portion 1123.

The central portion 1121 is formed in the center of the top surface 112a opposed to the liquid-crystal panel 2, and the center of the central portion 1121 (viz., the optical axis of the lens 112) is located on the optical axis S of the LED chip 111a. The central portion 1121 is circularly shaped in parallel with the light-emitting surface of the LED chip 111a, and a diameter L3 of the circular shape is set at 1 mm, for example. By way of another embodiment of the invention, instead of the circular shape, the central portion 1121 may be configured to be defined by a lateral surface of a cone having an imaginary circular base, the cone protruding toward the LED chip 111a from the imaginary circular base.

The central portion 1121 is formed to apply light to that region of the diffusion plate 3 acting as an object to be illuminated which faces the central portion 1121. However, since the central portion 1121 is a part opposed to the LED chip 111a, when most of light emitted from the LED chip 111a reaches the central portion 1121 and most part of the reaching light passes directly therethrough, then the illuminance of the region facing the central portion 1121 is significantly increased. With this in view, the shape of the central portion 1121 should preferably be defined by the lateral surface of the cone as described above. In the case where the shape of the central portion is defined by the lateral surface of the cone, most of light is reflected from the central portion 1121, wherefore the quantity of light which passes through the central portion 1121 is decreased, and consequently the illuminance of the region facing the central portion 1121 can be reduced.

The first curved portion 1122 is an annular curved surface which is continuous with an outer edge of the central portion 1121, and extends in one of the directions of the optical axis S of the LED chip 111a (the direction toward the liquid-crystal panel 2) as it extends outward, while being curved in convex form inwardly and in the one optical-axis S direction. The curved surface is designed for total reflection of light emitted from the LED chip 111a.

More specifically, out of light emitted from the LED chip 111a, light which has reached the first curved portion 1122 is totally reflected from the first curved portion 1122, is transmitted through the side surface 112b of the lens, and is directed toward the reflective member 113. Upon reaching the reflective member 113, the light is diffused by the reflective member 113, and is applied to that region of the diffusion plate 3 acting as the to-be-illuminated object which is not opposed to the LED chip 111a. In this way, the quantity of light applied to the region which is not confronted by the LED chip 111a can be increased.

In order to cause total reflection of light emitted from the LED chip 111a, the first curved portion 1122 is so configured that the incident angle of light emitted from the LED chip 111a is greater than or equal to a critical angle φ. For example, given that acrylic resin is used as the material for the lens 112, the refractive index of the acrylic resin is 1.49, whereas the refractive index of air is 1, wherefore the following relationship is obtained: sin φ=1/1.49. A critical angle φ of 42.1° is derived from this relational expression, and correspondingly the first curved portion 1122 is so configured that the incident angle is greater than or equal to 42.1°.

The second curved portion 1123 is an annular curved surface which is continuous with an outer edge of the first curved portion 1122, and extends in the other of the directions along the optical axis S of the LED chip 111a (the direction away from the liquid-crystal panel 2) as it extends outward, while being curved in convex form outwardly and in the one optical-axis S direction. In this embodiment, the lens 112 is disposed so that its bottom abuts against a base portion 1131 of the reflective member 113 that will be described below.

Out of light emitted from the LED chip 111a, light which has reached the second curved portion 1123 is refracted in a direction toward the light-emitting section 111 when passing through the second curved portion 1123 so as to travel toward the diffusion plate 3 and the reflective member 113. Upon reaching the reflective member 113, the light is diffused for travel toward the diffusion plate 3. The light thusly directed toward the diffusion plate 3 by the second curved portion 1123 is mainly applied to a region of the diffusion plate 3 that differs from the region thereof irradiated with light from the central portion 1121 and the first curved portion 1122, which makes up for the insufficiency of light quantity. Note that the second curved portion 1123 is required to allow transmission of light, and is therefore configured so that the incident angle is smaller than 42.1° to avoid total reflection of light emitted from the LED chip 111a.

Thus, in the lens 112, the outer edge of the central portion 1121 is formed with the first curved portion 1122 for totally reflecting light emitted from the LED chip 111a so that the light can be directed toward the side surface 112b of the lens 112, and the outer edge of the first curved portion 1122 is formed with the second curved portion 1123 for refracting light emitted from the LED chip 111a. In general, the LED chip 111a has high directivity, and the quantity of light in the vicinity of the optical axis S is very large, and thus, the quantity of light decreases as the exit angle of light with respect to the optical axis S increases. Accordingly, in order to increase the quantity of light applied to a region located relatively far away from the optical axis S of the LED chip 111a (viz., the optical axis of the lens 112), rather than light having a large exit angle with respect to the optical axis S, light having a small exit angle with respect to the optical axis S needs to be directed toward that region. In this embodiment, as has already been described, since the first curved portion 1122 for totally reflecting light toward that region is formed in contiguous relation around the central portion 1121 through which the optical axis S passes, it is possible to increase the quantity of light applied to that region. By contrast, if the second curved portion 1123 is formed in contiguous relation around the central portion 1121, and the first curved portion 1122 is formed in contiguous relation around the second curved portion 1123, light traveling toward the first curved portion 1122 will exhibit a larger exit angle with respect to the optical axis S, and consequently total reflection occurs at the first curved portion 1122, and thus the quantity of light applied to that region decreases.

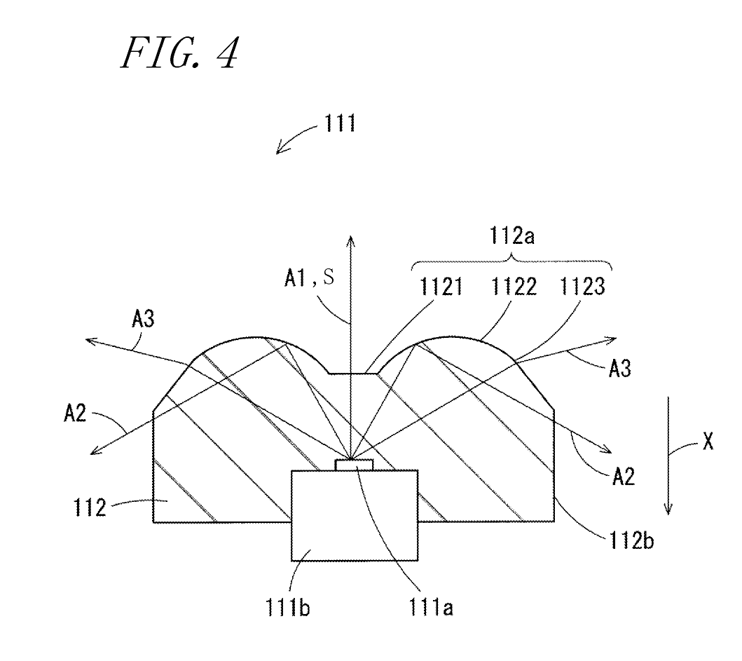

FIG. 4 is a view for explaining the optical path of light emitted from the LED chip 111a. Light emitted from the LED chip 111a enters the lens 112, and is then diffused by the lens 112. Specifically, out of light incident on the lens 112, light which has reached the central portion 1121 at the top surface 112a opposed to the liquid-crystal panel 2 is caused to exit in a direction indicated by arrow A1 toward the liquid-crystal panel 2; light which has reached the first curved portion 1122 is totally reflected therefrom to exit in a direction indicated by arrow A2 from the side surface 112b; and light which has reached the second curved portion 1123 is refracted outward (in a direction away from the LED chip 111a) to exit in a direction indicated by arrow A3 toward the liquid-crystal panel 2.

In this embodiment, the LED chip 111a and the lens 112 are formed in precise alignment with each other so that the lens 112 is placed in contact with the LED chip 111a, with its center (viz., the optical axis of the lens 112) located on the optical axis S of the LED chip 111a. As the technique of forming the LED chip 111a and the lens 112 in alignment in advance, a few ways will be considered, i.e. insert molding, and a method of fitting the LED chip 111a supported on the base support 111b in the lens 112 molded in a predetermined shape. In this embodiment, the LED chip 111a and the lens 112 are formed in alignment with each other in advance by insert molding.

Molds used for insert molding are broadly classified as an upper mold and a lower mold. In the molding process, a resin used as the raw material of the lens 112 is poured, through a resin inlet, into a space created by combining the upper mold and the lower mold, while retaining the LED chip 111a. Alternatively, the molding process may be carried out by pouring a resin used as the raw material of the lens 112 into a space created by combining the upper mold and the lower mold through a resin inlet, while retaining the LED chip 111a supported on the base support 111b. By forming the LED chip 111a and the lens 112 by means of insert molding in that way, it is possible to ensure precise alignment between the lens 112 and the LED chip 111a so that the lens 112 abuts on the LED chip 111a. Thus, the backlight unit 1 becomes capable of reflection and refraction of light emitted from the LED chip 111a with high accuracy by the action of the lens 112 contacted by the LED chip 111a, and accordingly, even in the low-profile liquid-crystal display apparatus 100 in which a distance H3 from the diffusion plate 3 to the printed substrate 12 is short, the liquid-crystal panel 2 can be irradiated with light with uniformity in the brightness of the liquid-crystal panel 2 in the planar direction thereof.

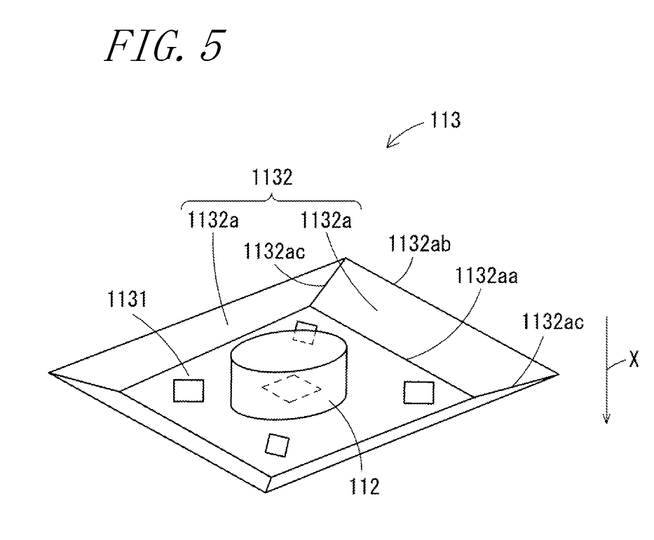

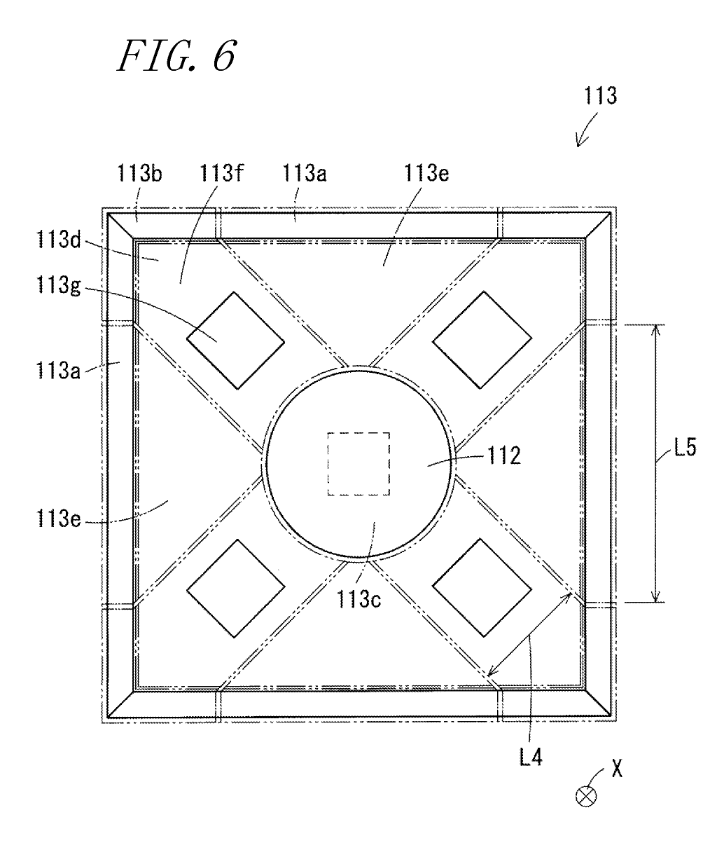

The reflective member 113 will be explained with reference to FIGS. 5 and 6. FIG. 5 is a perspective view of the reflective member 113 and the lens 112, and FIG. 6 is a view showing the reflective member 113 and the lens 112 as viewed in a plan view in the X direction. The reflective member 113 is a member for reflecting incident light toward the liquid-crystal panel 2. The reflective member 113 has a polygonal outer shape, for example, a square outer shape when viewed in a plan view in the X direction. The reflective member 113 comprises: a flat-plate base portion 1131, the shape of which is defined by a square which is 38.8 mm on a side, having a centrally-located opening; and an inclined portion 1132 which surrounds the base portion 1131, and is inclined so as to gradually separate from the printed substrate 12 with decreasing proximity to the LED chip 111a. The reflective member 113 comprising the base portion 1131 and the inclined portion 1132 has the form of an upside-down dome centering on the LED chip 111a disposed within the lens 112 (not represented graphically in FIGS. 5 and 6).

In this embodiment, the reflective member 113 is configured to have a square outer shape when viewed in a plan view in the X direction, and is also configured linearly symmetrically with respect to the diagonal line of the square shape. Also, the reflective member 113 is configured rotationally symmetrically through 90° about the center point of the square shape.

The base portion 1131 is so configured that each side of a square defining its shape as viewed in a plan view in the X direction becomes parallel to the direction of rows or columns of the matrix arrangement of a plurality of LED chips 111a. Moreover, the base portion 1131 is formed along the printed substrate 12, and has a square opening located in the center thereof as viewed in a plan view in the X direction. The length of one side of the square opening is substantially equal to the length L1 of one side of the base support 111b for supporting the LED chip 111a, so that the base support 111b is inserted through the opening.

The inclined portion 1132 is a collective term for four trapezoidal flat plates 1132a each having a trapezoidal main surface. In each of the trapezoidal flat plates 1132a, of the two opposed bases of the trapezoidal shape, the shorter one, namely a base 1132aa is continuous with each side of the square base portion 1131, and the longer one, namely a base 1132ab lies farther away from the printed substrate 12 than does the base portion 1131 in the X direction. The adjacent trapezoidal flat plates 1132a are continuous with each other at their legs 1132ac.

As shown in FIG. 2A, an angle of inclination θ1 between the trapezoidal flat plate 1132a and the printed substrate 12 is 80°, for example. Moreover, a height H2 of the inclined portion 1132 in the X direction is 3.5 mm, for example.

The base portion 1131 and the inclined portion 1132 are made of high-luminance PET (Polyethylene Terephthalate), aluminum, or the like. The high-luminance PET is foamed PET containing a fluorescent agent, and examples thereof include E60V (product name) manufactured by TORAY Industries, Inc. The base portion 1131 and the inclined portion 1132 have a thickness in a range of 0.1 to 0.5 mm, for example.

As shown in FIG. 6, when viewed in a plan view in the X direction, a region of the inclined portion 1132 corresponding to a corner of the square reflective member 113 will be referred to as a corner part 113b. Moreover, when viewed in a plan view in the X direction, a region of the inclined portion 1132 corresponding to a side of the square reflective member 113, except the corner part 113b, will be referred to as a side 113a. Moreover, when viewed in a plan view in the X direction, a region of the base portion 1131 disposed in overlapping relation to the lens 112 will be referred to as a central part 113c. Moreover, when viewed in a plan view in the X direction, a region of the base portion 1131 located between the corner part 113b and the central part 113c will be referred to as a first reflective region 113d. A width L4 of the first reflective region 113d falls in the range of 10 mm to 25 mm. Moreover, when viewed in a plan view in the X direction, a region of the base portion 1131 located between the side 113a and the central part 113c will be referred to as a second reflective region 113e. A width L5 of the second reflective region 113e falls in the range of 15 mm to 35 mm.

The first reflective region 113d has a first reference reflective portion 113f and a high-reflection portion 113g. The first reference reflective portion 113f is a part of the first reflective region 113d whose total reflectivity for visible light emitted from the LED chip 111a takes on a predetermined value, for example, 90% to 99%. The high-reflection portion 113g is a part of the first reflective region 113d whose total reflectivity is higher than the total reflectivity of the first reference reflective portion 113f.

The high-reflection portion 113g is formed by bonding a high-luminance PET sheet onto the base portion 1131. Alternatively, the reflective member 113 having the high-reflection portion 113g may be formed by molding high-luminance PET or the like using a mold having a mirror-finished portion. In this case, part of the base portion 1131 serves as the high-reflection portion 113g.

In this embodiment, the total reflectivity of the high-reflection portion 113g is 97%. Moreover, the total reflectivity of the first reference reflective portion 113f is 94%. Also, the second reflective region 113e, the side 113a, the corner part 113b, and the central part 113c exhibit a total reflectivity of 94%. As specified in JIS H 0201:1998, total reflectivity refers to the sum of specular reflectivity and diffuse reflectivity, and its measurement can be conducted in conformity to JIS K 7375.

In this embodiment, a diffuse reflection range of the high-reflection portion 113g is narrower than a diffuse reflection range of the second reflective region 113e. As used herein, the term “diffuse reflection range” refers to numerical values representing the degree of light diffusion at the occurrence of diffuse reflection at a certain surface. More specifically, in a situation where light having a predetermined spot diameter is caused to enter a certain surface at a predetermined incident angle so as to obtain a predetermined illuminance, a detector, which is placed away from the centroid of the surface by a certain distance substantially greater than the spot diameter and has a detecting surface having an area substantially smaller than the area of an imaginary spherical surface whose radius is equal to the certain distance, is moved to each and every location where an illuminance greater than or equal to a predetermined illuminance threshold is detected, and, an area of a curved surface which is part of the imaginary spherical surface made by the locus of the detecting surface of the moving detector is defined as the diffuse reflection range. When the area of the curved surface is large, it is indicated that the degree of light diffusion resulting from diffuse reflection is high, whereas, when the area of the curved surface is small, it is indicated that the degree of light diffusion resulting from diffuse reflection is low.

For example, the diffuse reflection range of the high-reflection portion 113g equals one-third to one-eighth of the diffuse reflection range of the second reflective region 113e. In this embodiment, the diffuse reflection ranges of the first reference reflective portion 113f, the side 113a, the corner part 113b, and the central part 113c are equal to the diffuse reflection range of the second reflective region 113e.

In this embodiment, a single high-reflection portion 113g is provided in a single first reflective region 113d. The high-reflection portion 113g is formed in the shape of a square in the center of the first reflective region 113d, and the length of one side of the square is 5 mm, for example. Moreover, in the first reflective region 113d, the other area than the high-reflection portion 113g serves as the first reference reflective portion 113f. Note that the number, shape, and size of the high-reflection portion 113g are not limited to those as described above.

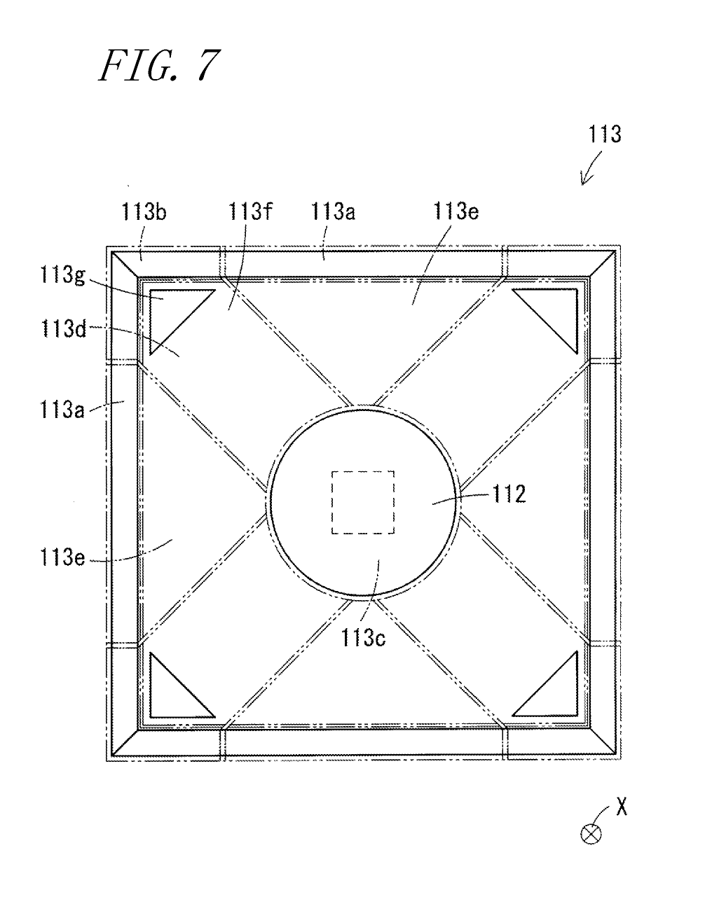

FIG. 7 shows a modified example of the first embodiment. In this modified example, a single isosceles-triangular high-reflection portion 113g is formed in a part of each of the first reflective regions 113d surrounded by the corner part 113b. The length of the oblique side of the isosceles-triangular high-reflection portion 113g is 8 mm, for example.

It is preferable that the thusly constructed reflective members 113 provided in their respective light-emitting devices 11 are integrally molded. As the method of integrally molding a plurality of reflective members 113, where the reflective member 113 is made of foamed PET, extrusion molding can be adopted, and, where the reflective member 113 is made of aluminum, press working can be adopted. By integrally molding the reflective members 113 respectively provided in the plurality of light-emitting sections 111, it is possible to improve the accuracy of placement positions of the plurality of light-emitting sections 111 relative to the printed substrate 12, as well as to reduce the number of process steps required for installation of the reflective members 113 during assembly of the backlight unit 1, with a consequent increase in the efficiency of assembly operation.

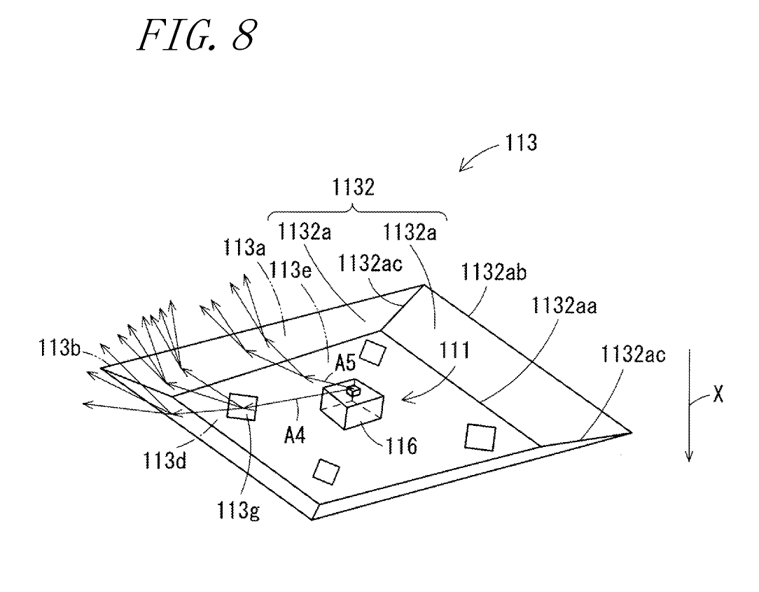

Referring to FIGS. 4 and 8, a description will be given below as to the optical path of light emitted from the LED chip 111a in the liquid-crystal display apparatus 100 equipped with the backlight unit 1 thusly constructed. FIG. 8 is a perspective view showing the light-emitting section 111 and the reflective member 113 shown in FIG. 6, wherein the lens 112 is omitted.

As has already been described, in the backlight unit 1, out of light that has been emitted from the LED chip 111a and entered the lens 112, light which has reached the central portion 1121 at the top surface 112a opposed to the liquid-crystal panel 2 is caused to exit in a direction indicated by arrow A1 toward the liquid-crystal panel 2; light which has reached the first curved portion 1122 is reflected therefrom to exit in a direction indicated by arrow A2 from the side surface 112b; and light which has reached the second curved portion 1123 is refracted outward to exit in a direction indicated by arrow A3 toward the liquid-crystal panel 2. The thusly emitted light is isotropically diffused in a planar direction perpendicular to the X direction.

Part of light directed from the central part 113c of the reflective member 113 toward the corner part 113b thereof in the planar direction perpendicular to the X direction travels along an optical path A4 as shown in FIG. 8, is specularly and diffusely reflected from the high-reflection portion 113g of the first reflective region 113d, and reaches the corner part 113b. Upon the light reaching the corner part 113b, specular reflection and diffuse reflection take place at the corner part 113b, and the light reaches a part of the liquid-crystal panel 2 opposed to the corner part 113b.

Moreover, part of light directed from the central part 113c of the reflective member 113 toward the side 113a thereof in the planar direction perpendicular to the X direction travels along an optical path A5 as shown in FIG. 8, is specularly and diffusely reflected from the second reflective region 113e, and reaches the side 113a. Upon the light reaching the side 113a, specular reflection and diffuse reflection take place at the side 113a, and the light reaches a part of the liquid-crystal panel 2 opposed to the side 113a.

In this way, light emitted from the LED chip 111a is reflected from the reflective member 113 so as to be applied to the liquid-crystal panel 2. Since the reflective member 113 has, in the first reflective region 113d thereof, the high-reflection portion 113g which exhibits a total reflectivity higher than the total reflectivities of the first reference reflective portion 113f, the side 113a, the corner part 113b, and the second reflective region 113e, it follows that the average total reflectivity between the corner part 113b and the first reflective region 113d is higher than the average total reflectivity between the side 113a and the second reflective region 113e. As used herein, the term “average total reflectivity” refers to a mean value of total reflectivity obtained by averaging all the data on total reflectivity of the surfaces with weight of the area of each surface.

In the reflective member 113, the average total reflectivity between the corner part 113b and the first reflective region 113d is higher than the average total reflectivity between the side 113a and the second reflective region 113e, with the consequence that the ratio of the quantity of light that has been reflected from the first reflective region 113d and the corner part 113b and has reached the liquid-crystal panel 2 to the quantity of light that has been reflected from the second reflective region 113e and the side 113a and has reached the liquid-crystal panel 2 becomes larger than ever. That is, the ratio of the quantity of light reaching the part of the liquid-crystal panel 2 opposed to the corner part 113b to the quantity of light reaching the part of the liquid-crystal panel 2 opposed to the side 113a becomes larger than ever. Thus, the backlight unit 1 is capable of affording uniformity of light applied to the liquid-crystal panel 2, wherefore the liquid-crystal display apparatus 100 equipped with the backlight unit 1 is capable of displaying images of even higher quality.

Moreover, in this embodiment, the diffuse reflection range of the high-reflection portion 113g is narrower than the diffuse reflection range of the second reflective region 113e. That is, light reflected from the high-reflection portion 113g is diffused over a range narrower than the range over which light reflected from the second reflective region 113e is diffused. Thus, the ratio of the quantity of light reaching the part of the liquid-crystal panel 2 opposed to the corner part 113b of the reflective member 113 to the quantity of light reaching the part of the liquid-crystal panel 2 opposed to the side 113a of the reflective member 113 can be increased even further than ever, wherefore the backlight unit 1 is capable of rendering light applied to the liquid-crystal panel 2 even more uniform.

Moreover, in this embodiment, the reflective member 113 comprises the base portion 1131 and the inclined portion 1132. Since the inclined portion 1132 is inclined so as to get closer to the liquid-crystal panel 2 as a distance from the LED chip 111a increases, it follows that light emitted from the LED chip 111a is readily caused to reach the part of the liquid-crystal panel 2 opposed to the side 113a, as well as the corner part 113b, of the reflective member 113. This allows the backlight unit 1 to render light applied to the liquid-crystal panel 2 even more uniform.

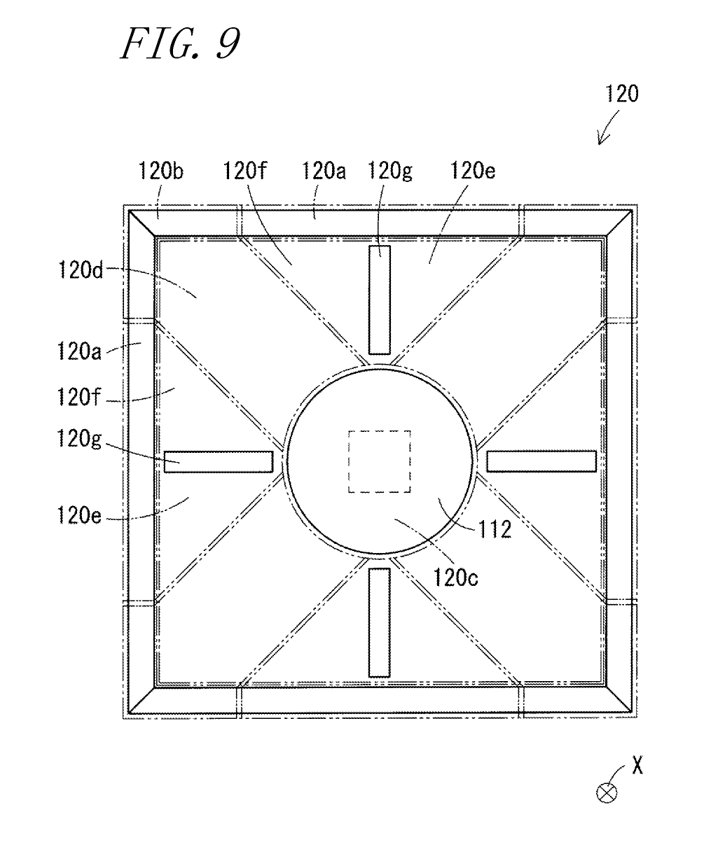

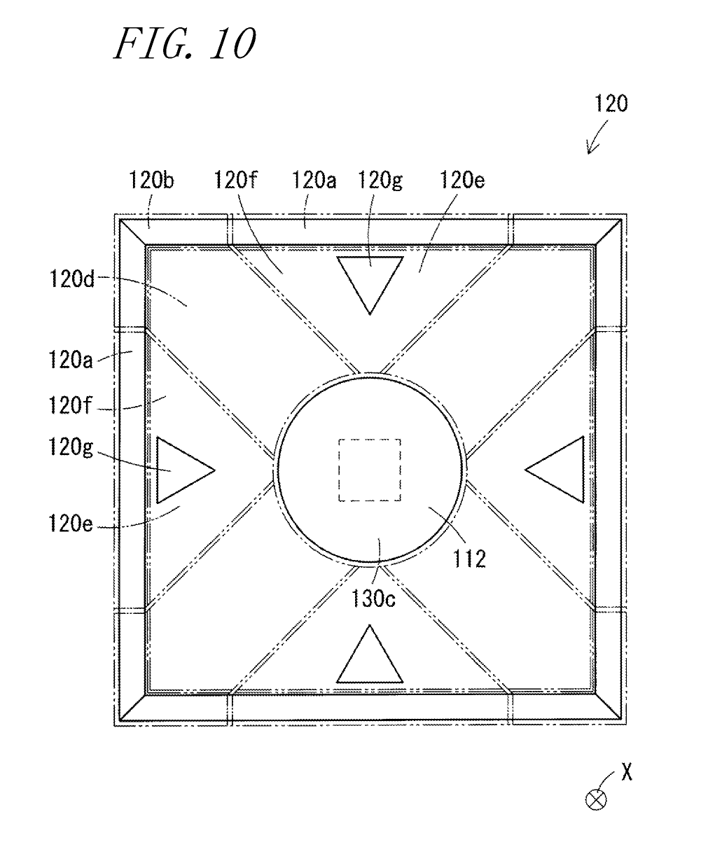

Next, a second embodiment of the invention will be described with reference to FIG. 9. In the second embodiment, a reflective member 120 is provided in place of the reflective member 113, and otherwise the second embodiment is structurally identical with the first embodiment, wherefore only the reflective member 120 will be described. Moreover, the reflective member 120 is structurally similar to the reflective member 113, wherefore the points of difference from the reflective member 113 will be mainly explained.

FIG. 9 is a view showing the reflective member 120 and the lens 112 as viewed in a plan view in the X direction. The reflective member 120 comprises, when viewed in a plan view in the X direction, a side 120a, a corner part 120b, a central part 120c, a first reflective region 120d, and a second reflective region 120e. The side 120a, the corner part 120b, the central part 120c, the first reflective region 120d, and the second reflective region 120e correspond to the side 113a, the corner part 113b, the central part 113c, the first reflective region 113d, and the second reflective region 113e, respectively, of the first embodiment.

The second reflective region 120e has a second reference reflective portion 120f and a first low-reflection portion 120g. The second reference reflective portion 120f is a part of the second reflective region 120e whose total reflectivity for visible light emitted from the LED chip 111a takes on a predetermined value, for example, 90% to 99%. The first low-reflection portion 120g is a part of the second reflective region 120e whose total reflectivity is lower than the total reflectivity of the second reference reflective portion 120f.

The first low-reflection portion 120g is formed by coloring part of the reflective member 120 with a black or gray coloring agent. The surface of the colored part may be roughened by means of sandblasting or otherwise.

The first low-reflection portion 120g has a total reflectivity in a range of 40% to 80%, for example, and, in this embodiment, the total reflectivity is 75%. Moreover, the total reflectivity of the second reference reflective portion 120f is 94%. Also, the first reflective region 120d, the side 120a, the corner part 120b, and the central part 120c exhibit a total reflectivity of 94%.

In this embodiment, a diffuse reflection range of the first low-reflection portion 120g is broader than a diffuse reflection range of the first reflective region 120d. For example, the diffuse reflection range of the first low-reflection portion 120g is 1.2 to 5 times the diffuse reflection range of the first reflective region 120d. In this embodiment, the diffuse reflection ranges of the second reference reflective portion 120f, the side 120a, the corner part 120b, and the central part 120c are equal to the diffuse reflection range of the first reflective region 120d.

In this embodiment, a single first low-reflection portion 120g is provided in a single second reflective region 120e. The first low-reflection portion 120g is formed in the center of the second reflective region 120e so as to have the shape of a rectangle extending from the central part 120c toward the side 120a of the reflective member 120, and, the length of the long side of the rectangle is 15 mm, for example, and the length of the short side of the rectangle is 3 mm, for example. Moreover, in the second reflective region 120e, the other area than the first low-reflection portion 120g serves as the second reference reflective portion 120f. Note that the number, shape, and size of the first low-reflection portion 120g are not limited to those as described above.

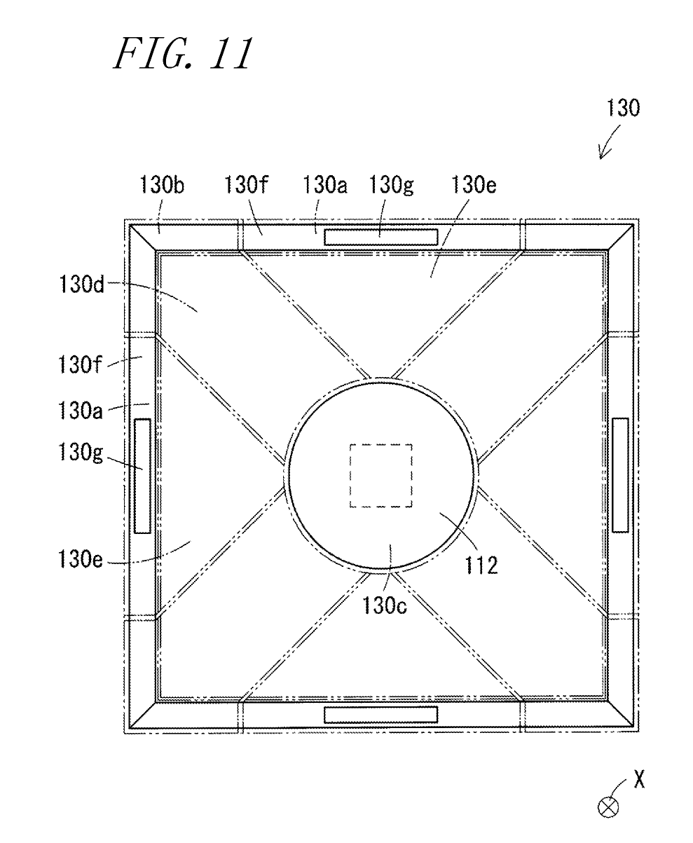

FIG. 10 shows a modified example of the second embodiment. In this modified example, a single equilateral-triangular first low-reflection portion 120g is formed in each of the second reflective regions 120e so as to be convexly curved in a direction from the side 120a to the central part 120c. The length of one side of the equilateral-triangular first low-reflection portion 120g is 3 mm, for example.

In the backlight unit 1 having the thusly constructed reflective member 120, light emitted from the LED chip 111a is reflected from the reflective member 120 so as to be applied to the liquid-crystal panel 2. Since the reflective member 120 has, in the second reflective region 120e thereof, the first low-reflection portion 120g which exhibits a total reflectivity lower than the total reflectivities of the second reference reflective portion 120f, the side 120a, the corner part 120b, and the first reflective region 120d, it follows that the average total reflectivity between the corner part 120b and the first reflective region 120d is higher than the average total reflectivity between the side 120a and the second reflective region 120e.

In the reflective member 120, the average total reflectivity between the corner part 120b and the first reflective region 120d is higher than the average total reflectivity between the side 120a and the second reflective region 120e, with the consequence that the ratio of the quantity of light that has been reflected from the first reflective region 120d and the corner part 120b and has reached the liquid-crystal panel 2 to the quantity of light that has been reflected from the second reflective region 120e and the side 120a and has reached the liquid-crystal panel 2 becomes larger than ever. That is, the ratio of the quantity of light reaching a part of the liquid-crystal panel 2 opposed to the corner part 120b to the quantity of light reaching a part of the liquid-crystal panel 2 opposed to the side 120a becomes larger than ever. Thus, the backlight unit 1 is capable of affording uniformity of light applied to the liquid-crystal panel 2, wherefore the liquid-crystal display apparatus 100 equipped with the backlight unit 1 is capable of displaying images of even higher quality.

Moreover, in this embodiment, the diffuse reflection range of the first low-reflection portion 120g is broader than the diffuse reflection range of the first reflective region 120d. That is, light reflected from the first low-reflection portion 120g is diffused over a range broader than the range over which light reflected from the first reflective region 120d is diffused. Thus, the ratio of the quantity of light reaching the part of the liquid-crystal panel 2 opposed to the corner part 120b of the reflective member 120 to the quantity of light reaching the part of the liquid-crystal panel 2 opposed to the side 120a of the reflective member 120 can be increased even further than ever, wherefore the backlight unit 1 is capable of rendering light applied to the liquid-crystal panel 2 even more uniform.

Next, a third embodiment of the invention will be described with reference to FIG. 11. In the third embodiment, a reflective member 130 is provided in place of the reflective member 113, and otherwise the third embodiment is structurally identical with the first embodiment, wherefore only the reflective member 130 will be described. Moreover, the reflective member 130 is structurally similar to the reflective member 113, wherefore the points of difference from the reflective member 113 will be mainly explained.

FIG. 11 is a view showing the reflective member 130 and the lens 112 as viewed in a plan view in the X direction. The reflective member 130 comprises, when viewed in a plan view in the X direction, a side 130a, a corner part 130b, a central part 130c, a first reflective region 130d, and a second reflective region 130e. The side 130a, the corner part 130b, the central part 130c, the first reflective region 130d, and the second reflective region 130e correspond to the side 113a, the corner part 113b, the central part 113c, the first reflective region 113d, and the second reflective region 113e, respectively, of the first embodiment.

The side 130a has a third reference reflective portion 130f and a second low-reflection portion 130g. The third reference reflective portion 130f is a part of the side 130a whose total reflectivity for visible light emitted from the LED chip 111a takes on a predetermined value, for example, 90% to 99%. The second low-reflection portion 130g is a part of the side 130a whose total reflectivity is lower than the total reflectivity of the third reference reflective portion 130f.

The second low-reflection portion 130g is formed by coloring part of the reflective member 130 with a black or gray coloring agent. The surface of the colored part may be roughened by means of sandblasting or otherwise.

The second low-reflection portion 130g has a total reflectivity in a range of 40% to 80%, for example, and, in this embodiment, the total reflectivity is 75%. Moreover, the total reflectivity of the third reference reflective portion 130f is 94%. Also, the first reflective region 130d, the second reflective region 130e, the corner part 130b, and the central part 130c exhibit a total reflectivity of 94%.

In this embodiment, a diffuse reflection range of the second low-reflection portion 130g is broader than a diffuse reflection range of the first reflective region 130d. For example, the diffuse reflection range of the second low-reflection portion 130g is 2 to 8 times the diffuse reflection range of the first reflective region 130d. In this embodiment, the diffuse reflection ranges of the third reference reflective portion 130f, the second reflective region 130e, the corner part 130b, and the central part 130c are equal to the diffuse reflection range of the first reflective region 130d.

In this embodiment, a single second low-reflection portion 130g is provided in a single side 130a. The second low-reflection portion 130g is formed in the center of the side 130a so as to have the shape of a rectangle extending along the direction of the length of the side 130a, and, the length of the long side of the rectangle is 8 mm, for example, and the length of the short side of the rectangle is 1.5 mm, for example. Moreover, in the side 130a, the other area than the second low-reflection portion 130g serves as the third reference reflective portion 130f. Note that the number, shape, and size of the second low-reflection portion 130g are not limited to those as described above.

In the backlight unit 1 having the thusly constructed reflective member 130, light emitted from the LED chip 111a is reflected from the reflective member 130 so as to be applied to the liquid-crystal panel 2. Since the reflective member 130 has, in the side 130a thereof, the second low-reflection portion 130g which exhibits a total reflectivity lower than the total reflectivities of the third reference reflective portion 130f, the corner part 130b, the first reflective region 130d, and the second reflective region 130e, it follows that the average total reflectivity between the corner part 130b and the first reflective region 130d is higher than the average total reflectivity between the side 130a and the second reflective region 130e.

In the reflective member 130, the average total reflectivity between the corner part 130b and the first reflective region 130d is higher than the average total reflectivity between the side 130a and the second reflective region 130e, with the consequence that the ratio of the quantity of light that has been reflected from the first reflective region 130d and the corner part 130b and has reached the liquid-crystal panel 2 to the quantity of light that has been reflected from the second reflective region 130e and the side 130a and has reached the liquid-crystal panel 2 becomes larger than ever. That is, the ratio of the quantity of light reaching a part of the liquid-crystal panel 2 opposed to the corner part 130b to the quantity of light reaching a part of the liquid-crystal panel 2 opposed to the side 130a becomes larger than ever. Thus, the backlight unit 1 is capable of affording uniformity of light applied to the liquid-crystal panel 2, wherefore the liquid-crystal display apparatus 100 equipped with the backlight unit 1 is capable of displaying images of even higher quality.

Moreover, in this embodiment, the diffuse reflection range of the second low-reflection portion 130g is broader than the diffuse reflection range of the first reflective region 130d. That is, light reflected from the second low-reflection portion 130g is diffused over a range broader than the range over which light reflected from the first reflective region 130d is diffused. Thus, the ratio of the quantity of light reaching the part of the liquid-crystal panel 2 opposed to the corner part 130b of the reflective member 130 to the quantity of light reaching the part of the liquid-crystal panel 2 opposed to the side 130a of the reflective member 130 can be increased even further than ever, wherefore the backlight unit 1 is capable of rendering light applied to the liquid-crystal panel 2 even more uniform.

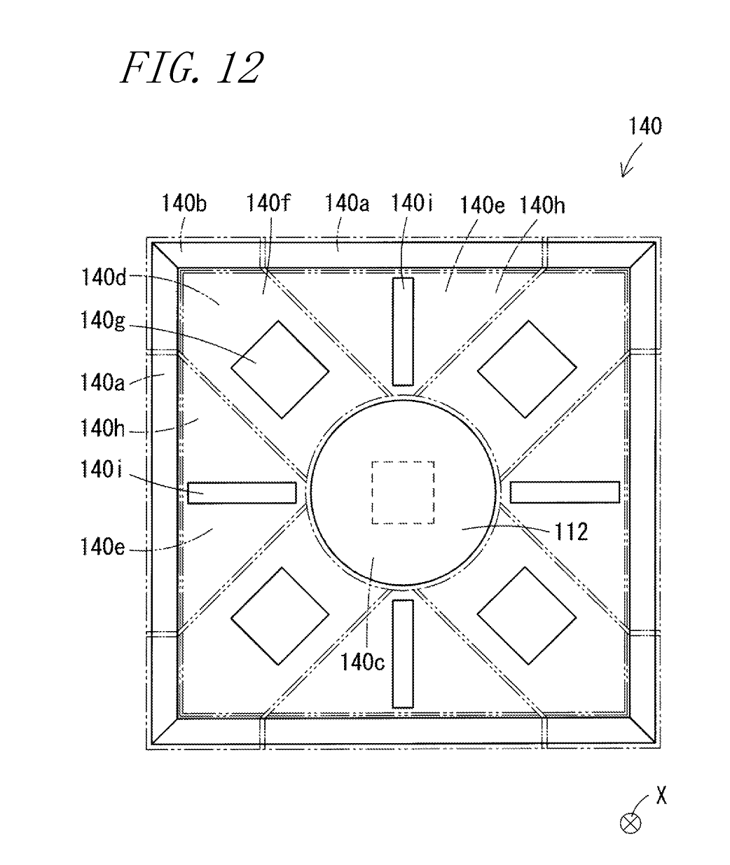

Next, a fourth embodiment of the invention will be described with reference to FIG. 12. In the fourth embodiment, a reflective member 140 is provided in place of the reflective member 113, and otherwise the fourth embodiment is structurally identical with the first embodiment, wherefore only the reflective member 140 will be described. Moreover, the reflective member 140 is structurally similar to the reflective member 113, wherefore the points of difference from the reflective member 113 will be mainly explained.

FIG. 12 is a view showing the reflective member 140 and the lens 112 as viewed in a plan view in the X direction. The reflective member 140 comprises, when viewed in a plan view in the X direction, a side 140a, a corner part 140b, a central part 140c, a first reflective region 140d, and a second reflective region 140e. The side 140a, the corner part 140b, the central part 140c, the first reflective region 140d, and the second reflective region 140e correspond to the side 113a, the corner part 113b, the central part 113c, the first reflective region 113d, and the second reflective region 113e, respectively, of the first embodiment.

The first reflective region 140d has a first reference reflective portion 140f and a high-reflection portion 140g. The first reference reflective portion 140f is a part of the first reflective region 140d whose total reflectivity for visible light emitted from the LED chip 111a takes on a predetermined value, for example, 90% to 99%. The high-reflection portion 140g is a part of the first reflective region 140d whose total reflectivity is higher than the total reflectivity of the first reference reflective portion 140f.

The high-reflection portion 140g is formed by bonding a high-luminance PET sheet onto the reflective member 140. Alternatively, the reflective member 40 having the high-reflection portion 140g may be formed by molding high-luminance PET or the like using a mold having a mirror-finished portion.

The second reflective region 140e has a second reference reflective portion 140h and a first low-reflection portion 140i. The second reference reflective portion 140h is a part of the second reflective region 140e whose total reflectivity is equal to the total reflectivity of the first reference reflective portion 140f. The first low-reflection portion 140i is a part of the second reflective region 140e whose total reflectivity is lower than the total reflectivity of the second reference reflective portion 140h.

The first low-reflection portion 140i is formed by coloring part of the reflective member 140 with a black or gray coloring agent. The surface of the colored part may be roughened by means of sandblasting or otherwise.

In this embodiment, the total reflectivity of the high-reflection portion 140g is 97%. Moreover, the first low-reflection portion 140i has a total reflectivity in a range of 40% to 80%, for example, and, in this embodiment, the total reflectivity is 75%. In addition, the first reference reflective portion 140f, the second reference reflective portion 140h, the side 140a, the corner part 140b, and the central part 140c exhibit a total reflectivity of 94%.

In this embodiment, a diffuse reflection range of the high-reflection portion 140g is narrower than a diffuse reflection range of the second reference reflective portion 140h of the second reflective region 140e. For example, the diffuse reflection range of the high-reflection portion 140g equals one-third to one-eighth of the diffuse reflection range of the second reference reflective portion 140h. Moreover, in this embodiment, a diffuse reflection range of the first low-reflection portion 140i is broader than a diffuse reflection range of the first reference reflective portion 140f of the first reflective region 140d. For example, the diffuse reflection range of the first low-reflection portion 140i is 1.2 to 5 times the diffuse reflection range of the first reference reflective portion 140f. In this embodiment, the diffuse reflection ranges of the first reference reflective portion 140f, the second reference reflective portion 120h, the side 120a, the corner part 120b, and the central part 120c are equal to one another.

In this embodiment, a single high-reflection portion 140g is provided in a single first reflective region 140d. The high-reflection portion 140g is formed in the shape of a square in the center of the first reflective region 140d, and the length of one side of the square is 5 mm, for example. Moreover, in the first reflective region 140d, the other area than the high-reflection portion 140g serves as the first reference reflective portion 140f. Note that the number, shape, and size of the high-reflection portion 140g are not limited to those as described above.

Moreover, in this embodiment, a single first low-reflection portion 140i is provided in a single second reflective region 140e. The first low-reflection portion 140i is formed in the shape of a rectangle in the center of the second reflective region 140e, and the length of the long side of the rectangle is 15 mm, for example, and the length of the short side of the rectangle is 2 mm, for example. Moreover, in the second reflective region 140e, the other area than the first low-reflection portion 140i serves as the second reference reflective portion 140h. Note that the number, shape, and size of the first low-reflection portion 140i are not limited to those as described above.

In the backlight unit 1 having the thusly constructed reflective member 140, light emitted from the LED chip 111a is reflected from the reflective member 140 so as to be applied to the liquid-crystal panel 2. The reflective member 140 has, in the first reflective region 140d thereof, the high-reflection portion 140g which exhibits a total reflectivity higher than the total reflectivities of the first reference reflective portion 140f, the side 140a, the corner part 140b, the second reference reflective portion 140h, and the first low-reflection portion 140i, and also has, in the second reflective region 140e thereof, the first low-reflection portion 140i which exhibits a total reflectivity lower than the total reflectivities of the second reference reflective portion 140h, the side 140a, the corner part 140b, the first reference reflective portion 140f, and the high-reflection portion 140g. Accordingly, the average total reflectivity between the corner part 140b and the first reflective region 140d is higher than the average total reflectivity between the side 140a and the second reflective region 140e.

In the reflective member 140, the average total reflectivity between the corner part 140b and the first reflective region 140d is higher than the average total reflectivity between the side 140a and the second reflective region 140e, with the consequence that the ratio of the quantity of light that has been reflected from the first reflective region 140d and the corner part 140b and has reached the liquid-crystal panel 2 to the quantity of light that has been reflected from the second reflective region 140e and the side 140a and has reached the liquid-crystal panel 2 becomes larger than ever. That is, the ratio of the quantity of light reaching a part of the liquid-crystal panel 2 opposed to the corner part 140b to the quantity of light reaching a part of the liquid-crystal panel 2 opposed to the side 140a becomes larger than ever. Thus, the backlight unit 1 is capable of affording uniformity of light applied to the liquid-crystal panel 2, wherefore the liquid-crystal display apparatus 100 equipped with the backlight unit 1 is capable of displaying images of even higher quality.

Moreover, in this embodiment, the diffuse reflection range of the high-reflection portion 140g is narrower than the diffuse reflection range of the second reflective region 140e, and the diffuse reflection range of the first low-reflection portion 140i is broader than the diffuse reflection range of the first reflective region 140d. That is, light reflected from the high-reflection portion 140g is diffused over a range narrower than the range over which light reflected from the second reflective region 140e is diffused, and light reflected from the first low-reflection portion 140i is diffused over a range broader than the range over which light reflected from the second reflective region 140e is diffused. Thus, the ratio of the quantity of light reaching the part of the liquid-crystal panel 2 opposed to the corner part 140b of the reflective member 140 to the quantity of light reaching the part of the liquid-crystal panel 2 opposed to the side 140a of the reflective member 140 can be increased even further than ever, wherefore the backlight unit 1 is capable of rendering light applied to the liquid-crystal panel 2 even more uniform.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

1: Backlight unit
2: Liquid-crystal panel
100: Liquid-crystal display apparatus
111a: LED chip
111b: Base support
112: Lens
113, 120, 130, 140: Reflective member
113a, 120a, 130a, 140a: Side
113b, 120b, 130b, 140b: Corner part
113c, 120c, 130c, 140c: Central part
113d, 120d, 130d, 140d: First reflective region
113e, 120e, 130e, 140e: Second reflective region
113f, 140f: First reference reflective portion
113g, 140g: High-reflection portion
120f, 140h: Second reference reflective portion
120g, 140i: First low-reflection portion
130f: Third reference reflective portion
130g: Second low-reflection portion

1. A light-emitting device for illuminating an object to be illuminated, comprising:
a light-emitting section for applying light to a to-be-illuminated object; and
a reflective member disposed around the light-emitting section,
the reflective member being polygonal in outer shape as viewed in a plan view from a to-be-illuminated object side,
when viewed in a plan view from the to-be-illuminated object side, an average total reflectivity between a total reflectivity of a corner part of the reflective member and a total reflectivity of a first reflective region, which is a region between the corner part and the light-emitting section, is greater than an average total reflectivity between a total reflectivity of a side of the reflective member and a total reflectivity of a second reflective region, which is a region between the side and the light-emitting section,
the light-emitting section being located in a center of the reflective member as viewed in a plan view from the to-be-illuminated object side.

2. The light-emitting device according to claim 1,
wherein the reflective member has, in the first reflective region thereof, a first reference reflective portion having a predetermined total reflectivity and a high-reflection portion having a total reflectivity higher than the predetermined total reflectivity, and
total reflectivities of the corner part, the side, and the second reflective region are equal to the predetermined total reflectivity.

3. The light-emitting device according to claim 1,
wherein the reflective member has, in the second reflective region thereof, a second reference reflective portion having a predetermined total reflectivity and a first low-reflection portion having a total reflectivity lower than the predetermined total reflectivity, and
total reflectivities of the corner part, the side, and the first reflective region are equal to the predetermined total reflectivity.

4. The light-emitting device according to claim 1,
wherein the reflective member has, in the side thereof, a third reference reflective portion having a predetermined total reflectivity and a second low-reflection portion having a total reflectivity lower than the predetermined total reflectivity, and
total reflectivities of the corner part, the first reflective region, and the second reflective region are equal to the predetermined total reflectivity.

5. The light-emitting device according to claim 1,
wherein the reflective member has, in the first reflective region thereof, a first reference reflective portion having a predetermined total reflectivity and a high-reflection portion having a total reflectivity higher than the predetermined total reflectivity, and has, in the second reflective region thereof, a second reference reflective portion having a predetermined total reflectivity and a first low-reflection portion having a total reflectivity lower than the predetermined total reflectivity, and
total reflectivities of the corner part and the side are equal to the predetermined total reflectivity.

6. The light-emitting device according to claim 2,
wherein a diffuse reflection range of the high-reflection portion is narrower than a diffuse reflection range of the second reflective region.

7. The light-emitting device according to claim 3,
wherein a diffuse reflection range of the first low-reflection portion is broader than a diffuse reflection range of the first reflective region.

8. The light-emitting device according to claim 4,
wherein a diffuse reflection range of the second low-reflection portion is broader than a diffuse reflection range of the first reflective region.

9. The light-emitting device according to claim 5,
wherein a diffuse reflection range of the high-reflection portion is narrower than a diffuse reflection range of the first reference reflective portion,
a diffuse reflection range of the first low-reflection portion is broader than the diffuse reflection range of the first reference reflective portion, and
a diffuse reflection range of the second reference reflective portion is equal to the diffuse reflection range of the first reference reflective portion.

10. The light-emitting device according to claim 1,
wherein the reflective member comprises a base portion which surrounds the light-emitting element, and an inclined portion which surrounds the base portion and is inclined so as to get closer to the to-be-illuminated object as a distance from the light-emitting element increases.

11. A display apparatus, comprising:
a display panel; and
an illuminating apparatus including a light-emitting device for applying light to a back side of the display panel,
the light-emitting device being the light-emitting device according to claim 1.
